(19) United States
(12) Patent Application Publication
(10) Pub. No.: US 2024/0205139 A1
(43) Pub. Date: Jun. 20, 2024

(54) COMMUNICATION SYSTEM AND COMMUNICATION CONTROL METHOD

(71) Applicant: RAKUTEN MOBILE, INC., Tokyo (JP)

(72) Inventor: Kazushige TAKEUCHI, Setagaya-ku, Tokyo (JP)

(21) Appl. No.: 17/906,746

(22) PCT Filed: May 31, 2021
(86) PCT No.: PCT/JP2021/020675

§ 371 Date: Sep. 19, 2022

(51) Int. Cl. H04L 45/28; H04L 45/00

(52) U.S. Cl. CPC H04L 45/28; H04L 45/26

(57) ABSTRACT

Provided are a communication system and a communication control method which are capable of suppressing occurrence of wasted traffic due to transmission of BFD packets that are not effectively utilized. A bfdd transmits and receives BFD packets to and from a bfdd included in a CDC cluster. A CRC restricts, in response to detection of no transmission of BFD packets from the bfdd, transmission of the BFD packets to the bfdd by the bfdd.

### TECHNICAL FIELD

The present invention relates to a communication system and a communication control method.

### BACKGROUND ART

Bidirectional forwarding detection (BFD) protocol is a protocol in which a first bidirectional forwarding detection daemon (bfdd) and a second bfdd transmit and receive BFD packets to and from each other in order to detect a path failure between the first bfdd and the second bfdd. As an example of a failure detection technology using the BFD protocol, in Patent Literature 1, there is described a technology for detecting that a primary pseudowire has changed to a failed status by a bidirectional forwarding detection (BFD) session.

### CITATION LIST

### Patent Literature

[Patent Literature 1] WO 2018/050120 A1

### SUMMARY OF INVENTION

### Technical Problem

In the BFD protocol, the first bfdd periodically transmits BFD packets to the second bfdd at short time intervals (for example, at intervals of several milliseconds) regardless of whether or not the second bfdd is operating normally.

There may occur a situation in which, for example, a failure occurs at a node on which the second bfdd is operating, and thus the BFD packets transmitted from the first bfdd are not properly processed by the second bfdd. During the period in which such a situation is occurring, the BFD packets transmitted from the first bfdd are not effectively utilized. As a result, the transmission of the BFD packets by the first bfdd is wasted traffic.

The present invention has been made in view of the above-mentioned actual situation, and has an object to provide a communication system and a communication control method which are capable of suppressing occurrence of wasted traffic due to transmission of BFD packets that are not effectively utilized.

### Solution to Problem

In order to solve the above-mentioned problem, according to one embodiment of the present invention, there is provided a communication system including: a first bidirectional forwarding detection daemon (bfdd); and transmission restriction means, wherein the first bfdd is configured to transmit and receive BFD packets to and from a second bfdd which is a bfdd included in a communication partner of the communication system, and wherein the transmission restriction means is configured to restrict, in response to detection of no transmission of BFD packets from the second bfdd, transmission of the BFD packets to the second bfdd by the first bfdd.

In one aspect of the present invention, the transmission restriction means is configured to lengthen, in response to the detection, an interval of the transmission of the BFD packets to the second bfdd by the first bfdd.

As another example, the transmission restriction means is configured to stop, in response to the detection, the transmission of the BFD packets to the second bfdd by the first bfdd.

Further, in one aspect of the present invention, the communication system further includes transmission restriction release means for releasing, when the transmission of the BFD packets is restricted, the restriction on the transmission of the BFD packets in response to detection of a recovery of a bfdd included in the communication partner.

In this aspect, the communication system may further include address data reception means for receiving address data indicating an address of a third bfdd which is the bfdd included in the communication partner after the recovery, and the transmission restriction release means may be configured to release the restriction on the transmission of the BFD packets in response to the receiving of the address data.

As another example, the communication system may further include address data acquisition means for accessing a storage unit configured to store address data indicating an address of the bfdd included in the communication partner to acquire the address data, and the transmission restriction release means may be configured to release the restriction on the transmission of the BFD packets in response to detection of a change in the address indicated by the address data.

Further, according to one embodiment of the present invention, there is provided a communication control method including the steps of: transmitting, by a first bidirectional forwarding detection daemon (bfdd) included in a communication system, BFD packets to a second bfdd which is a bfdd included in a communication partner of the communication system; receiving, by the first bfdd, the BFD packets transmitted from the second bfdd; and restricting, in response to detection of no transmission of BFD packets from the second bfdd, transmission of the BFD packets to the second bfdd by the first bfdd.

### BRIEF DESCRIPTION OF DRAWINGS

FIG. 1 is a diagram for illustrating a configuration of a computer system in which a cluster of nodes for executing containerized applications are constructed.

FIG. 2 is a diagram for illustrating an example of a DNS record stored in a coreDNS of a GC cluster.

FIG. 3 is a diagram for illustrating a configuration of the computer system in which a cluster of nodes for executing containerized applications are constructed.

FIG. 4 is a flow chart for illustrating an example of a flow of a process executed in the GC cluster in one embodiment of the present invention.

FIG. 5 is a flow chart for illustrating an example of a flow of a process executed in the GC cluster in the one embodiment of the present invention.

### DESCRIPTION OF EMBODIMENTS

One embodiment of the present invention is now described in detail with reference to the drawings.

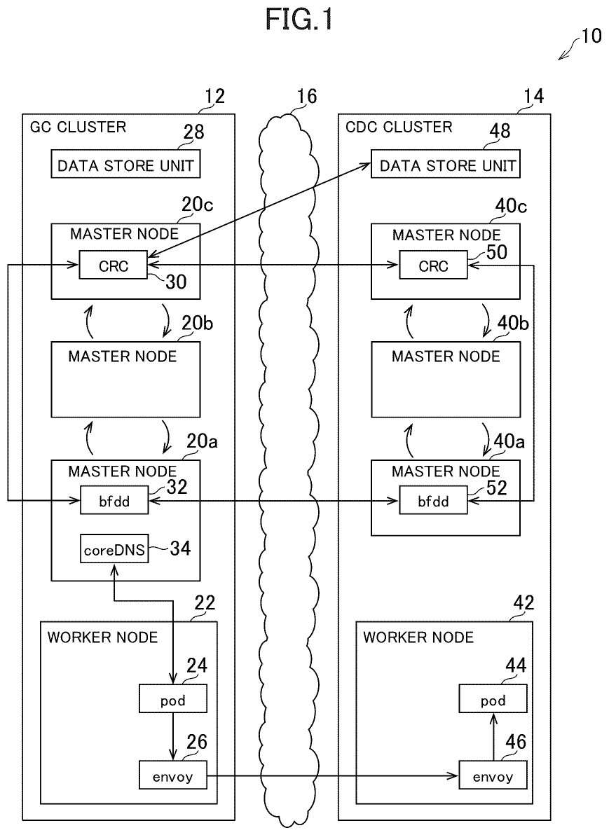

FIG. 1 is a diagram for illustrating an example of a communication system 10 according to one embodiment of the present invention. As illustrated in FIG. 1, the communication system 10 according to this embodiment includes a GC cluster 12 and a CDC cluster 14. The GC cluster 12 and the CDC cluster 14 in this embodiment are computer systems in which a cluster of nodes (which can also be said to be computers or servers) for executing containerized applications is constructed.

The GC cluster 12 is a cluster constructed in a group unit center (GC) station of a mobile communications carrier.

The CDC cluster 14 is a cluster constructed in a central data center (CDC) of a mobile communications carrier.

The clusters in this embodiment are sets of nodes in which software (specifically, Kubernetes) for managing containerized workloads and services is installed. Further, the clusters in this embodiment are each a Kubernetes cluster for which a manageable range of pods, which are containerized applications, is defined. A Kubernetes cluster can also be said to be a set of a plurality of nodes on which Kubernetes can deploy a pod.

The communication system 10 includes a plurality of GC clusters 12 and a plurality of CDC clusters 14, but in FIG. 1, one GC cluster 12 and one CDC cluster 14 are representatively illustrated.

The GC cluster 12 is connected to the CDC cluster 14 via a WAN 16 including a L2 communication section.

The GC cluster 12 includes a plurality of master nodes 20 (master node 20a, master node 20b, and master node 20c) and a plurality of worker nodes 22 (in FIG. 1, one node is illustrated).

In the worker node 22, a pod 24 is deployed. The pod 24 is a containerized application for executing various data processes (for example, business operation process). The pod 24 can also be said to be a cloud-native network function (CNF) instance.

An envoy 26 is also arranged in the worker node 22. The envoy 26 can be said to be a proxy unit, specified by a publicly known service mesh, which performs, by proxy, hooking of transmission data output from a transmission source application and transmission of the transmission data to a transmission destination application in accordance with a predetermined communication protocol.

Each of the plurality of master nodes 20 is a node which manages a plurality of worker nodes 22 and a plurality of pods 24.

In the example of FIG. 1, the GC cluster 12 includes a data store unit 28. The data store unit 28 includes, for example, kube-apiserver and a data store such etcd, which are Kubernetes components.

The GC cluster 12 also includes a custom resource controller (CRC) 30 and a bidirectional forwarding detection daemon (bfdd) 32. In the example of FIG. 1, the CRC 30 is arranged in the master node 20c, and the bfdd 32 is arranged in the master node 20a. In this embodiment, the CRC 30 and the bfdd 32 are not instantiated until the setup relating to the initial setting described below is performed.

The GC cluster 12 also includes a coreDNS 34 for executing name resolution of a transmission destination of the target data for the pod 24 included in the cluster. In the example of FIG. 1, the coreDNS 34 is arranged in the master node 20a.

As illustrated in FIG. 1, the CDC cluster 14 includes a plurality of master nodes 40 (master node 40a, master node 40b, and master node 40c) and a plurality of worker nodes 42 (in FIG. 1, one node is illustrated).

In the worker node 42, a pod 44 is deployed. The pod 44 is a containerized application for executing various data processes (for example, business operation process). The pod 44 can also be said to be a cloud-native network function (CNF) instance.

An envoy 46 is also arranged in the worker node 42. The envoy 46 can be said to be a proxy unit, specified by a publicly known service mesh, which performs, by proxy, hooking of transmission data output from a transmission source application and transmission of the transmission data to a transmission destination application in accordance with a predetermined communication protocol.

Each of the plurality of master nodes 40 is a node which manages a plurality of worker nodes 42 and a plurality of pods 44.

In the example of FIG. 1, the CDC cluster 14 includes a data store unit 48. The data store unit 48 includes, for example, kube-apiserver and a data store such as etcd, which are Kubernetes components.

The CDC cluster 14 includes a CRC 50 and a bfdd 52. In the example of FIG. 1, the CRC 50 is arranged in the master node 40c, and the bfdd 52 is arranged in the master node 40a. In this embodiment, the CRC 50 and the bfdd 52 are already operating during the setup relating to the initial setting described below.

The address data indicating the IP address of the bfdd 52 and authentication information required for authentication of the bfdd 52 are registered in advance in the data store unit 48 of the CDC cluster 14.

In this embodiment, for example, in the setup relating to the initial setting, a plug-in definition (custom resource definition) for handling information on an opposite cluster is registered in the data store unit 28 of the GC cluster 12 by an operation of a developer, for example.

The GC cluster 12 then executes instantiation of the custom resource controller (CRC) 30. Here, for example, the instantiation of the CRC 30 is executed for the master node 20c.

Further, the CRC 30 executes instantiation of the bidirectional forwarding detection daemon (bfdd) 32 in the GC cluster 12. Here, for example, the instantiation of the bfdd 32 is executed for the master node 20a.

In this embodiment, the address data indicating the IP address of the bfdd 32 and the authentication information required for authentication of the bfdd 32 are registered in the data store unit 28 of the GC cluster 12.

Further, resource information (custom resource) on an opposite cluster (for example, CDC cluster 14) is registered in the data store unit 28 of the GC cluster 12 by an operation of the developer, for example.

The registered resource information is, for example, information indicating the address of the CDC cluster 14 (for example, IP address and domain name of the kube-apiserver included in the data store unit 48), and authentication information (credentials), such as a username and password, which is required for establishing communication to and from the CDC cluster 14.

The CRC 30 of the GC cluster 12 reads the registered resource information and executes a connection (negotiation) with the CDC cluster 14. In the connection, the address of the CDC cluster 14 indicated in the resource information is used. Further, in the connection, authentication using the authentication information indicated in the resource information is also executed.

Further, in the connection, the GC cluster 12 transmits to the CDC cluster 14 the address data indicating the IP address of the bfdd 32 and the authentication information required for authentication of the bfdd 32. Then, as a response to the transmission, the CDC cluster 14 transmits to the GC cluster 12 the address data indicating the IP address of the bfdd 52 and the authentication information required for authentication of the bfdd 52.

When the authentication is successful, it is confirmed whether the resource information on the CDC cluster 14 is registered in the data store unit 48 of the CDC cluster 14. When the resource information on the CDC cluster 14 is not registered, the CRC 30 of the GC cluster 12 registers the resource information on the CDC cluster 14 in the data store unit 48 of the CDC cluster 14. The CDC cluster 14 may register the resource information on the CDC cluster 14 in the data store unit 48 of the CDC cluster 14.

Further, the CDC cluster 14 registers the address data indicating the IP address of the bfdd 32 and the authentication information required for authentication of the bfdd 32, which are received from the GC cluster 12, in the data store unit 48. Further, the GC cluster 12 registers the address data indicating the IP address of the bfdd 52 and the authentication information required for authentication of the bfdd 52, which are received from the CDC cluster 14, in the data store unit 28.

In this way, the GC cluster 12 can identify the IP address of the bfdd 52 by referring to the address data registered in the data store unit 28. Further, the CDC cluster 14 can identify the IP address of the bfdd 32 by referring to the address data registered in the data store unit 48.

The CRC 30 then instructs the bfdd 32 to connect to the bfdd 52. Then, negotiation between the bfdd 32 and the bfdd 52 is executed. As a result, communication between the bfdd 32 and the bfdd 52 (a bidirectional forwarding detection (BFD) session) is established, and the transmission destination and transmission timing of the BFD packet are set.

When the BFD session is established between the bfdd 32 and the bfdd 52, communication of BFD packets is started between the bfdd 32 and the bfdd 52 in accordance with a BFD protocol.

In this embodiment, for example, the bfdd 32 transmits and receives BFD packets to and from the bfdd 52 included in the CDC cluster 14, which is the communication partner. Further, the bfdd 52 transmits and receives BFD packets to and from the bfdd 32 included in the GC cluster 12, which is the communication partner. In this embodiment, for example, BFD packets are transmitted every few milliseconds.

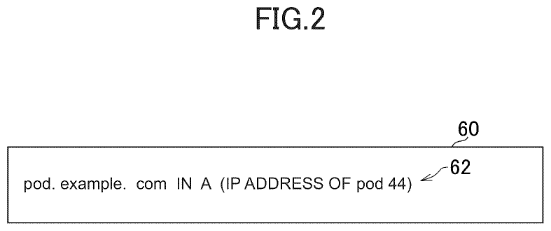

In this embodiment, for example, a DNS record 60 exemplified in FIG. 2 is registered in the coreDNS 34 of the GC cluster 12 in accordance with an operation of the developer. The DNS record 60 illustrated in FIG. 2 includes an A record 62 in which a transmission destination virtual domain name (pod.example.com) corresponding to a group including the pod 44 of the CDC cluster 14 and the IP address of the pod 44 of the CDC cluster 14 are associated with each other.

Further, in this embodiment, for example, the pod 24 of the GC cluster 12 transmits data relating to an application process (hereinafter also referred to as “target data”) to the pod 44 of the CDC cluster 14 via the envoy 26 and the envoy 46. The target data includes, for example, process results of the pod 24 deployed in the GC cluster 12.

In the transmission of the target data, the pod 24 of the GC cluster 12 requests the coreDNS 34 to resolve the name of, for example, the transmission destination pod name (for example, transmission destination virtual domain name virtualizing a plurality of pods including the pod 44). The coreDNS 34 sends back the IP address of the pod 44 to the pod 24 in the same cluster based on the DNS record 60. The pod 24 transmits the target data to the pod 44 of the CDC cluster 14 based on the IP address of the pod 44 provided from the coreDNS 34.

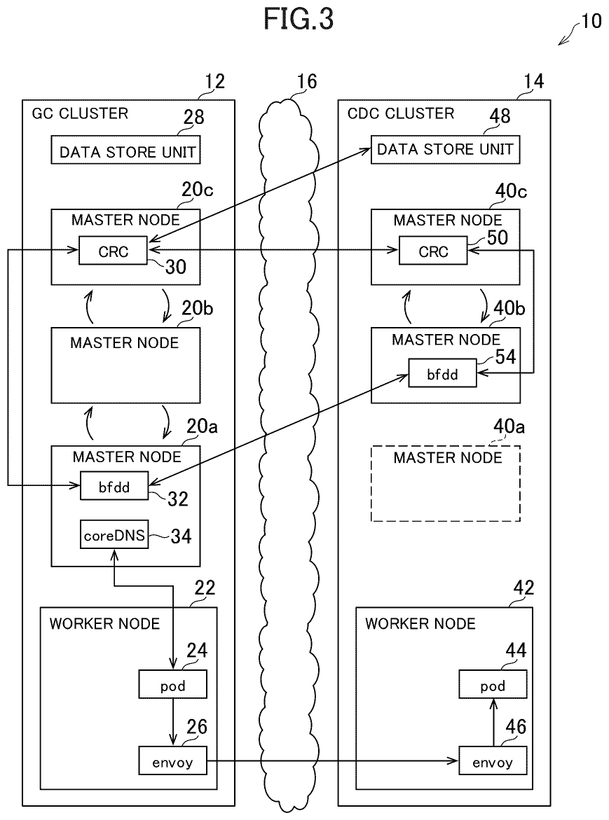

In this embodiment, it is assumed that, when the GC cluster 12 and the CDC cluster 14 are operating as described above, as illustrated in FIG. 3, a node failure has occurred in the master node 40a of the CDC cluster 14 in which the bfdd 52 is operating.

In this case, the bfdd 32 detects no transmission of BFD packets from the bfdd 52 (for example, bfdd 32 stops receiving BFD packets from the bfdd 52 for a predetermined period of time or more).

The CRC 30 restricts, in response to the detection of no transmission of BFD packets from the bfdd 52, transmission of the BFD packets by the bfdd 32 to the bfdd 52.

The CRC 30 may lengthen an interval of transmission of the BFD packets to the bfdd 52 by the bfdd 32 in response to the detection of no transmission of BFD packets from the bfdd 52. For example, the CRC 30 may set the interval of transmission of the BFD packets to the bfdd 52 by the bfdd 32 to several seconds or several tens of seconds (for example, from 20 seconds to 60 seconds).

As another example, the CRC 30 may stop, in response to the detection of no transmission of BFD packets from the bfdd 52, transmission of the BFD packets by the bfdd 32 to the bfdd 52.

Further, when a node failure has occurred in the master node 40a, the CRC 50 detects the loss of the bfdd 52. In response to the detection of the loss of the bfdd 52, the CRC 50 recovers the bfdd included in the CDC cluster 14. In the example of FIG. 3, the bfdd 54 recovered in this way is shown in the master node 40b. Here, an IP address different from that of the bfdd 52 is set in the bfdd 54.

The CRC 50 updates the address data indicating the IP address of the bfdd 52 registered in the data store unit 48 of the CDC cluster 14 to address data indicating the changed IP address (IP address set in the bfdd 54). Here, the CRC 50 may register the authentication information required for authentication of the bfdd 54 in the data store unit 48.

In this embodiment, for example, the CRC 30 then detects the recovery of a bfdd included in the CDC cluster 14 when the transmission of the BFD packets is restricted.

In this embodiment, for example, the CRC 30 then releases the restriction on transmission of the BFD packets in response to the detection of the recovery of a bfdd included in the CDC cluster 14. Here, for example, the CRC 30 may output to the bfdd 32 an instruction to change a pairing from the bfdd 52 to the bfdd 54. Then, in response to reception of the pairing change instruction, the bfdd 32 may establish a BFD session with the bfdd 54. Then, normal BFD packet communication in accordance with the BFD protocol may be initiated between the bfdd 32 and the bfdd 54. In the communication, the BFD packets may be transmitted at intervals of several milliseconds, for example.

For example, in response to the recovery of a bfdd included in the CDC cluster 14, the CRC 50 may transmit address data indicating the address of the bfdd 54, which is the bfdd included in the CDC cluster 14 after the recovery, to the GC cluster 12. The CRC 30 included in the GC cluster 12 may receive the address data. The CRC 30 may then release the restriction on transmission of the BFD packets in response to the reception of the address data. Here, the CRC 50 may also transmit the authentication information required for authentication of the bfdd 54 to the GC cluster 12. The CRC 30 may then receive the authentication information.

As another example, the CRC 30 may access the data store unit 48 at predetermined time intervals (for example, every 30 seconds to 1 minute) to acquire the address data being registered in the data store unit 48 and indicating the address (for example, IP address) of the bfdd included in the CDC cluster 14.

The CRC 30 may detect a change in the address indicated by the acquired address data. The CRC 30 may then release the restriction on transmission of the BFD packets in response to the detection of the change in the address indicated by the acquired address data. For example, the CRC 30 may acquire the authentication information required for authentication of the bfdd 54 from the data store unit 48.

Further, the CRC 30 updates the address data indicating the IP address of the bfdd 52 registered in the data store unit 28 of the GC cluster 12 to address data indicating the changed IP address (IP address set in the bfdd 54) in response to the detection of the recovery of the bfdd included in the CDC cluster 14. Here, the CRC 30 may register the authentication information required for authentication of the bfdd 54 in the data store unit 28.

The CRC 30 may rewrite the DNS record 60 registered in the coreDNS 34 in response to detection of no transmission of BED packets from the bfdd 54. For example, the A record 62 included in the DNS record 60 may be rewritten to an A record 62 in which the transmission destination virtual domain name (pod.example.com) and the IP address of the pod of another CDC cluster which is a backup of the CDC cluster 14 are associated with each other.

As described above, in this embodiment, the CRC 30 plays a role as a transmission restriction module for restricting transmission of the BFD packets to the bfdd 52 by the bfdd 32 in response to detection of no transmission of BFD packets from the bfdd 52.

Further, the CRC 30 plays a role as a transmission restriction release module for releasing, when transmission of the BFD packets is restricted, the restriction on transmission of the BFD packets in response to detection of a recovery of a bfdd included in the CDC cluster 14.

Moreover, the CRC 30 may play a role as an address data reception module for receiving address data indicating the address of the bfdd 54 which is the bfdd included in the CDC cluster 14 after the recovery.

In addition, the CRC 30 may play a role as an address data acquisition module for accessing the data store unit 48 storing address data indicating an address of a bfdd included in the CDC cluster 14 to acquire the address data.

FIG. 1 and FIG. 3 include block diagrams for illustrating functional blocks included in each component of the communication system 10. Each block illustrated in the block diagram of FIG. 1 or FIG. 3 can be implemented, in terms of hardware, by elements such as a CPU and a memory of a computer and mechanical devices, and can be implemented, in terms of software, by computer programs and the like, but functional blocks implemented by cooperation therebetween are illustrated here. A person skilled in the art would understand that those functional blocks can be implemented in various forms by the combinations of hardware and software.

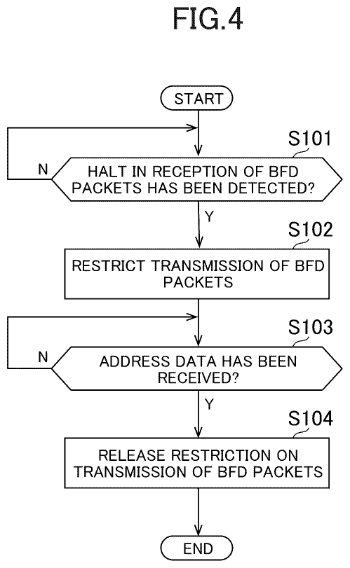

With reference to a flow chart exemplified in FIG. 4, description is now given of an example of a flow of a process relating to BFD packet transmission control executed in the GC cluster 12 in this embodiment.

In this process example, the bfdd 32 transmits BFD packets at predetermined time intervals (for example, at intervals of several milliseconds) to the bfdd 52, and monitors (waits for) the reception of the BFD packets transmitted from the bfdd 52 (Step S101).

When the bfdd 32 detects a halt in reception of the BED packets from the bfdd 52 for a predetermined period of time or more, the CRC 30 instructs the bfdd 32 to restrict transmission of the BFD packets. Then, the bfdd 32 restricts transmission of the BED packets as described above (Step S102).

The CRC 30 then monitors (waits for) the reception of address data from the CRC 50 (Step S103).

When the CRC 30 detects the reception of the address data from the CRC 50, the CRC 30 releases the restriction on transmission of the BFD packets (Step S104), and the process illustrated in this process example ends.

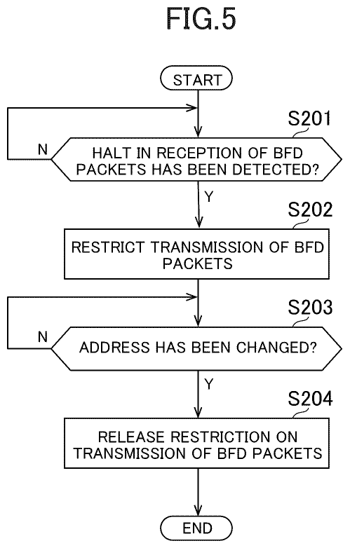

Next, with reference to a flow chart exemplified in FIG. 5, description is now given of another example of a flow of a process relating to the BFD packet transmission control executed in the GC cluster 12 in this embodiment.

In this process example, for example, it is assumed that the CRC 30 accesses the data store unit 48 at predetermined time intervals (for example, every 30 seconds to 1 minute) to acquire the address data indicating the IP address of the bfdd included in the CDC cluster 14.

Further, also in this process example, the bfdd 32 transmits BFD packets at predetermined time intervals (for example, at intervals of several milliseconds) to the bfdd 52, and monitors (waits for) the reception of the BFD packets transmitted from the bfdd 52 (Step S201).

When the bfdd 32 detects a halt in reception of the BED packets from the bfdd 52 for a predetermined period of time or more, the CRC 30 instructs the bfdd 32 to restrict transmission of the BFD packets. Then, the bfdd 32 restricts transmission of the BFD packets as described above (Step S202).

Then, the CRC 30 monitors a change in the address (for example, IP address) indicated by the address data acquired at the predetermined time intervals (Step S203).

When the CRC 30 detects a change in the address indicated by the address data, the CRC 30 releases the restriction on transmission of the BFD packets (Step S204), and the process illustrated in this process example ends.

In this process example, it is not required that the acquisition by the CRC 30 of the address data indicating the IP address of the bfdd included in the CDC cluster 14 at predetermined time intervals be executed in advance. For example, in response to transmission of the BFD packets being restricted, the CRC 30 may start the acquisition of the address data being registered in the data store unit 48 and indicating the IP address of the bfdd included in the CDC cluster 14 at predetermined time intervals.

Further, in the process step of Step S104 or Step S204, as described above, the CRC 30 may output to the bfdd 32 an instruction to change the pairing from the bfdd 52 to the bfdd 54, and then a BFD session between the bfdd 32 and the bfdd 54 may be established. Further, in the process step of Step S104 or Step S204, as described above, the updating of the address data registered in the data store unit 28 and the registration of the authentication information may be executed in conjunction.

Further, in this embodiment, the CRC 30 may execute both the monitoring of the reception of the address data from the CRC 50 and the acquisition at predetermined time intervals of the address data being registered in the data store unit 48 and indicating the IP address of the bfdd included in the CDC cluster 14. The restriction on transmission of the BFD packets may be released in response to the detection of any one of reception of the address data from the CRC 50 and a change in the address indicated by the address data.

Further, in this embodiment, access from the bfdd 54 to the bfdd 32 may occur in response to the recovery of a bfdd included in the CDC cluster 14. Moreover, the restriction on transmission of the BFD packets may be released in response to the detection of the occurrence of access from the bfdd 54 to the bfdd 32.

There may occur a situation in which, for example, a failure occurs at the master node 40a, and thus the BFD packets transmitted from the bfdd 32 are not properly processed by the bfdd 52. During the period in which such a situation is occurring, the BFD packets transmitted from the bfdd 32 are not effectively utilized. As a result, the transmission of the BED packets by the bfdd 32 is wasted traffic.

In this embodiment, as described above, the GC cluster 12 restricts, in response to the detection of no transmission of BFD packets from the bfdd 52, the transmission of the BFD packets by the bfdd 32. In this way, according to this embodiment, it is possible to suppress the occurrence of wasted traffic due to the transmission of BFD packets that are not effectively utilized.

Note that, the present invention is not limited to the embodiment described above.

For example, one CRC 30 may play a role in the connection (negotiation) with the opposite cluster, and another CRC 30 may play a role in the restriction on transmission of the BED packets. Moreover, those CRCs 30 may be arranged in separate master nodes 20.

The GC cluster 12 may further include the CRC 50, and a CRC 30 having the functions of the CRC 50 may operate on the GC cluster 12. The CDC cluster 14 may further include the CRC 30, and a CRC 50 having the functions of the CRC 30 may operate on the CDC cluster 14.

Further, the bfdd 32 and the coreDNS 34 may operate on the same master node 20, or may operate on different master nodes 20. Further, the CRC 30 and the bfdd 32 may operate on the same master node 20, or may operate on different master nodes 20. Further, the CRC 30 and the coreDNS 34 may operate on the same master node 20, or may operate on different master nodes 20.

Further, the CRC 50 and the bfdd 52 may operate on the same master node 40, or may operate on different master nodes 40.

1. A communication system, comprising:
at least one processor; and
at least one memory device storing instructions which, when executed by the at least one processor, cause the at least one processor to perform operations comprising:
executing a first bidirectional forwarding detection daemon (bfdd) which transmits and receives BFD packets to and from a second bfdd which is a bfdd included in a communication partner of the communication system, and
restricting, in response to detection of no transmission of BFD packets from the second bfdd, transmission of the BFD packets to the second bfdd by the first bfdd.

2. The communication system according to claim 1, wherein the restricting comprises lengthening, in response to the detection, an interval of the transmission of the BFD packets to the second bfdd by the first bfdd.

3. The communication system according to claim 1, wherein the restricting comprises stopping, in response to the detection, the transmission of the BFD packets to the second bfdd by the first bfdd.

4. The communication system according to claim 1, wherein the operations further comprise releasing, when the transmission of the BFD packets is restricted, the restriction on the transmission of the BFD packets in response to detection of a recovery of a bfdd included in the communication partner.

5. The communication system according to claim 4, wherein the operations further comprise receiving address data indicating an address of a third bfdd which is the bfdd included in the communication partner after the recovery,
wherein the releasing comprises releasing the restriction on the transmission of the BFD packets in response to the receiving of the address data.

6. The communication system according to claim 4, wherein the operations further comprise accessing a storage which stores address data indicating an address of the bfdd included in the communication partner to acquire the address data,
wherein the releasing comprises releasing the restriction on the transmission of the BFD packets in response to detection of a change in the address indicated by the address data.

7. A communication control method, comprising:
transmitting, by a first bidirectional forwarding detection daemon (bfdd) included in a communication system, BFD packets to a second bfdd which is a bfdd included in a communication partner of the communication system;
receiving, by the first bfdd, the BFD packets transmitted from the second bfdd; and
restricting, in response to detection of no transmission of BFD packets from the second bfdd, transmission of the BFD packets to the second bfdd by the first bfdd.
